(19) United States
(12) Patent Application Publication
(10) Pub. No.: US 2022/0082485 A1
(43) Pub. Date: Mar. 17, 2022

(54) DEVICE FOR MEASURING AMOUNT OF MOISTURE GENERATED IN LIVESTOCK SHELTER FLOORING MATERIAL

(71) Applicant: SEOUL NATIONAL UNIVERSITY R&DB FOUNDATION, Seoul (KR)

(72) Inventors: In Bok LEE, Anyang-si, Gyeonggi-do (KR); Sang Yeon LEE, Seoul (KR); Rack Woo KIM, Ansan-si, Gyeonggi-do (KR); Uk Hyeon YEO, Seoul (KR); Jun Gyu KIM, Seoul (KR)

(73) Assignee: SEOUL NATIONAL UNIVERSITY R&DB FOUNDATION, Seoul (KR)

(21) Appl. No.: 17/426,575

(22) PCT Filed: May 6, 2020
(86) PCT No.: PCT/KR2020/005935

§ 371 Date: Jul. 28, 2021

(30) Foreign Application Priority Data
Oct. 30, 2019 (KR) 10-2019-0136777

(51) Int. Cl. G01N 5/04; A01K 1/00

(52) U.S. Cl. CPC G01N 5/045; A01K 1/0052

(57) ABSTRACT

The present invention relates to a device for measuring the amount of moisture generated in a livestock shelter flooring material and can measure the amount of moisture generated in a flooring material according to the temperature, relative humidity, wind velocity, and flooring material moisture content conditions inside a livestock shelter.

### TECHNICAL FIELD

The present invention relates to a device for measuring an amount of moisture generated in a livestock shelter flooring material.

### BACKGROUND ART

A smart farm refers to a system that may appropriately maintain and manage the growing environments of crops, livestock, and fish using technology, such as Internet of Things (IoT), big data, artificial intelligence, etc., and may remotely control the growing environments using personal computers (PCs), smartphones, etc. Through smart farm technology using information and communication technologies, crops, livestock and fish may be precisely managed and predicted in respective growth stages based on accurate data regarding environmental information (temperature, relative humidity, an amount of light, carbon dioxide, soil, etc.) and growth information, and thus, the yield and quality of the crops, livestock and fish may be improved, thereby being capable of improving profitability.

As smart farm projects are being vigorously promoted recently, livestock shelter advancement is being continuously performed. Particularly, the floor of a livestock shelter serves not only to prevent contamination of the livestock shelter but also to reduce bad smell through moisture adjustment. Further, in order to control a moisture environment inside the livestock shelter, quantitative evaluation of temperature and humidity environments inside the livestock shelter is necessary.

A lot of research or tests on factors influencing the temperature environment inside livestock shelters have been performed, but little research or tests on the humidity environment inside livestock shelters have been done until now. Particularly, research on an amount of moisture generated in a flooring material which directly influences the moisture environment inside livestock shelters is needed.

### DISCLOSURE

### Technical Problem

Therefore, the present invention has been made in view of the above problems, and it is an object of the present invention to provide a device which may measure the amount of moisture generated in a flooring material directly influencing the moisture environment inside a livestock shelter.

### Technical Solution

In accordance with the present invention, the above and other objects can be accomplished by the provision of a device for measuring an amount of moisture generated in a livestock shelter flooring material, the device including a chamber configured to form an inner space therein, exhaust fans provided on one side surface of the chamber, a mesh unit installed on a remaining side surface of the chamber opposite the exhaust fans and configured to allow external air to flow into the inner space by the exhaust fans, and a tray configured such that a flooring material as a target to be measured is placed thereon, and selectively combined with the chamber.

Sliding guide parts may be provided at lower ends of side surfaces of the chamber, sliding coupling parts may be provided at upper ends of side surfaces of the tray, and thereby, the chamber and the tray may be combined with each other in a sliding manner.

A plurality of bolt coupling holes may be formed in the sliding guide parts and the sliding coupling parts, and the sliding guide parts and the sliding coupling parts may be fixedly combined with each other by bolts and nuts using the bolt coupling holes.

A packing member may be placed in each of the sliding guide parts, so as to allow the chamber and the tray to be tightly combined with each other when the chamber and the tray are fixedly coupled with each other.

The exhaust fans may include a plurality of fans provided in parallel.

The chamber may include a controller configured to control a rotational speed of the exhaust fans.

The mesh unit may be a honeycomb-type mesh net.

The external air flowing into the inner space of the chamber may form an air flow having straightness.

### Advantageous Effects

A device for measuring an amount of moisture generated in a livestock shelter flooring material according to the present invention is capable of measuring the amount of moisture generated in the flooring material depending on the temperature, relative humidity, wind velocity, and moisture content condition of the flooring material inside a livestock shelter.

### DESCRIPTION OF DRAWINGS

FIG. 1 is a perspective view exemplarily illustrating a device for measuring an amount of moisture generated in a livestock shelter flooring material according to the present invention.

FIG. 2 is a front view exemplarily illustrating a plurality of exhaust fans provided on the device for measuring the amount of moisture according to the present invention.

FIG. 3 is a front view exemplarily illustrating a mesh net provided on the device for measuring the amount of moisture according to the present invention.

FIG. 4 is a perspective view exemplarily illustrating a state in which a tray (40) is combined with a chamber (10) of the device for measuring the amount of moisture according to the present invention.

FIG. 5 is a side view exemplarily illustrating a state in which the tray (40) is detached from the chamber (10) of the device for measuring the amount of moisture according to the present invention.

### MODE FOR INVENTION

Preferred embodiments of the present invention will be described in detail with reference to the accompanying drawings in order to allow the present invention to be fully understood. The embodiments of the present invention may be variously modified, and it is interpreted that the embodiments described in detail below do not limit the scope of the invention. The embodiments have been disclosed for illustrative purposes to those skilled in the art. Therefore, in the drawings, the shapes of elements may be exaggerated so as to more clearly illustrate the embodiments. In the drawings, the same or similar elements are denoted by the same reference numerals even though they are depicted in different drawings. In the following description of the present invention, a detailed description of known functions and configurations incorporated herein will be omitted when it may make the subject matter of the present invention rather unclear.

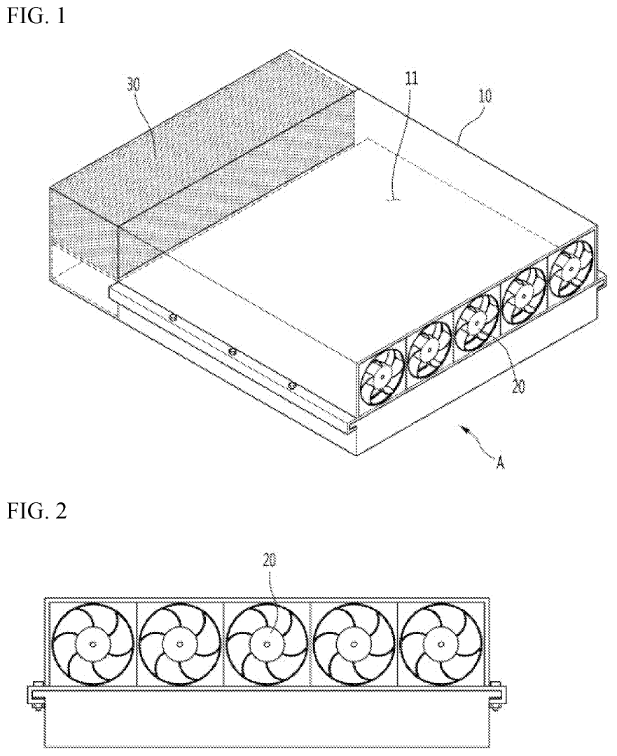

FIG. 1 is a perspective view exemplarily illustrating a device for measuring an amount of moisture generated in a livestock shelter flooring material according to the present invention.

The device for measuring the amount of moisture generated in the livestock shelter flooring material according to the present invention measures the amount of moisture generated in the flooring material used on the floor of a livestock shelter depending on the temperature, relative humidity and wind velocity and moisture content condition of the flooring material inside the livestock shelter.

As shown in FIG. 1, the device for measuring the amount of moisture generated in the livestock shelter flooring material according to the present invention includes a chamber 10 configured to form an inner space 11 therein, exhaust fans 20 provided on one side surface of the chamber 10, a mesh unit 30 installed on the other side surface of the chamber 10 opposite the exhaust fans 20 and configured to allow external air A to flow into the inner space 11 by the exhaust fans 20, and a tray 40 configured such that a flooring material B as a target to be measured is placed thereon, and selectively combined with the chamber 10.

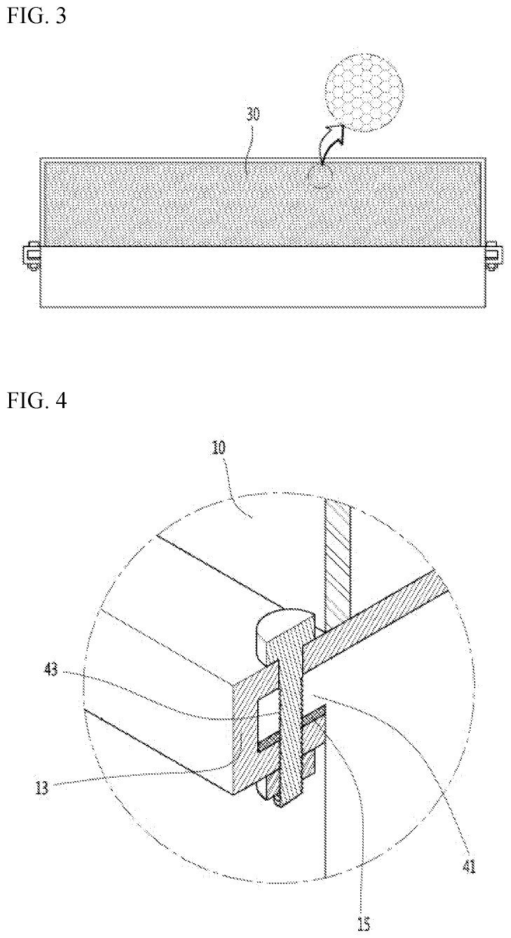

As shown in FIGS. 2 and 3, in the device for measuring the amount of moisture generated in the livestock shelter flooring material according to the present invention, the exhaust fans 20 are provided on one side surface of the chamber 10, and the mesh unit 30 is provided on the other side surface of the chamber 10 opposite the exhaust fans 20. The external air A may flow into the device through the mesh unit 30, and internal air may be discharged to the outside through the exhaust fans 20. Thereby, a flow velocity is formed inside the inner space 11.

As the exhaust fans 20 according to the present invention, a plurality of fans may be provided in parallel, and the number of the fans may vary depending on the size of the device for measuring the amount of moisture according to the present invention or the size of the exhaust fans which are installed. Further, the flow velocity formed inside the inner space 11 may not exceed 3 m/s at maximum. In the present invention, for example, five exhaust fans having a diameter of 0.092 m may be provided, and the total air volume of the five exhaust fans may be equal to or greater than 0.15 m³s⁻¹ so as to form the flow velocity of up to 3 m/s inside the chamber.

The mesh unit 30 according to the present invention may be configured such that the external air A flowing into the inner space 11 of the chamber 10 forms an air flow having straightness. Preferably, a honeycomb-type mesh net may be used. The honeycomb-type mesh net according to the present invention is configured, for example, to have a width of 0.15 m, a length of 0.5 m and a height of 0.1 m.

The chamber 10 according to the present invention may include the inner space 11 in which an air flow is formed, and an upper plate of the chamber 10 may be formed of a acrylic panel so that the inside of the chamber 10 is visible through the upper plate when tests are conducted. Preferably, in order to reduce errors when the weights of samples are measured, the upper plate of the chamber may be formed of an anti-static acrylic panel. The chamber 10 according to the present invention is configured, for example, to have a width of 0.5 m, a length of 0.5 m and a height of 0.1 m.

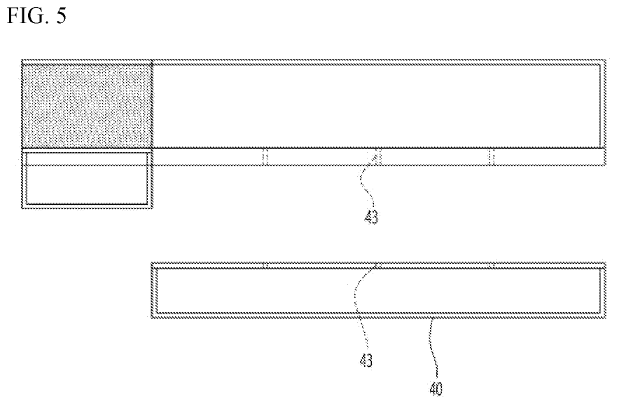

Further, the tray 40 according to the present invention may be combined with or detached from the chamber 10, as shown in FIGS. 4 and 5. When the height of the flooring material B is measured, the tray 40 may be detached from the chamber 10, thereby facilitating measurement of the weight of the flooring material B. The tray 40 according to the present invention is configured, for example, to have a width of 0.5 m, a length of 0.5 m and a height of 0.05 m.

Sliding guide parts 13 are provided at the lower ends of the side surfaces of the chamber 10, sliding coupling parts 41 are provided at the upper ends of the side surfaces of the tray 40, and thereby, the chamber 10 and the tray 40 may be combined with each other in a sliding manner.

Further, because the device for measuring the amount of moisture according to the present invention is exhausted in a negative pressure type, when a gap occurs between the chamber 10 and the tray 40, the air flow formed in the inner space 11 may be affected. Therefore, a rubber packing may be used to prevent occurrence of a gap between the chamber 10 and the tray 40 when the chamber 10 and the tray 40 are combined with each other. For example, a plurality of bolt coupling holes 43 may be formed in the sliding guide parts 13 and the sliding coupling parts 41, and the sliding guide parts 13 and the sliding coupling parts 41 may be fixedly combined with each other by bolts and nuts using the bolt coupling holes 43. A packing member 15 may be placed in each of the sliding guide parts 13, so as to allow the chamber 10 and the tray 40 to be tightly combined with each other when the chamber 10 and the tray 40 are fixedly combined with each other.

The chamber 10 according to the present invention may include a controller (not shown) which may control the rotational speed of the exhaust fans 20. The controller, which is a device configured to control the flow velocity formed inside the chamber 10, may adjust the flow velocity formed in the test unit into 10 levels by connecting variable resistors to the exhaust fans 20.

The above-described device for measuring the amount of moisture according to the present invention may be formed of, for example, stainless steel, and may be disposed in a separate constant temperature and humidity tank (not shown) so as to measure the amount of moisture. One example of measurement of the amount of moisture in the livestock shelter flooring material B will be described as follows.

The livestock shelter flooring material B is dried at a temperature of 60° C. for 48 hours, and then, the weight of the livestock shelter flooring material B is measured. The livestock shelter flooring material B is adjusted so as to have a specific moisture content, i.e., so as to satisfy a moisture content condition, by adding water to the livestock shelter flooring material B, and the livestock shelter flooring material B containing water is agitated, is contained in an airtight container, and is stored for 24 hours. Thereafter, after the flooring material B having the adjusted moisture content is placed on the tray 40 of the device for measuring the amount of moisture according to the present invention and the weight of the tray 40 having the flooring material B is measured, the device for measuring the amount of moisture is assembled, and then a test on the device for measuring the amount of moisture is performed in the constant temperature and humidity tank in which temperature and humidity conditions are satisfied. After the test, the tray 40 is detached from the device for measuring the amount of moisture, the weight of the flooring material B is measured, and an amount of moisture generated in the flooring material per unit time and per unit area is calculated through a weight difference before and after the test.

The above-described embodiment of the device for measuring the amount of moisture generated in the livestock shelter flooring material according to the present invention is merely exemplary, and those skilled in the art will appreciate that various modifications, additions and substitutions are possible, without departing from the scope and spirit of the invention as disclosed in the accompanying claims. The present invention as described above is not limited by the aspects described herein or the accompanying drawings. Therefore, the scope of the present invention is defined not by the detailed description, but by the claims and their equivalents. Further, it will be understood that all variations within the scope of the claims and their equivalents are to be construed as being included in the present invention.

### DESCRIPTION OF REFERENCE NUMERALS AND MARKS

10: chamber
11: inner space
13: sliding guide part
15: packing member
20: exhaust fan
30: mesh unit
40: tray
41: sliding coupling part
43: bolt coupling hole
A: external air
B: flooring material

### INDUSTRIAL APPLICABILITY

The floor of a livestock shelter serves not only to prevent contamination of the livestock shelter but also to reduce bad smell through moisture adjustment. Particularly, in order to control a moisture environment inside the livestock shelter, quantitative evaluation of temperature and humidity environments inside the livestock shelter is necessary. A device for measuring an amount of moisture generated in a livestock shelter flooring material according to the present invention is capable of measuring the amount of moisture generated in the flooring material depending on the temperature, relative humidity, wind velocity, and moisture content condition of the flooring material inside a livestock shelter.

1. A device for measuring an amount of moisture generated in a livestock shelter flooring material, the device comprising:
a chamber configured to form an inner space therein;
exhaust fans provided on one side surface of the chamber;
a mesh unit installed on a remaining side surface of the chamber opposite the exhaust fans and configured to allow external air to flow into the inner space by the exhaust fans; and
a tray configured such that a flooring material as a target to be measured is placed thereon, and selectively combined with the chamber.

2. The device for measuring the amount of moisture according to claim 1, wherein:
sliding guide parts are provided at lower ends of side surfaces of the chamber;
sliding coupling parts are provided at upper ends of side surfaces of the tray; and
thereby, the chamber and the tray are combined with each other in a sliding manner.

3. The device for measuring the amount of moisture according to claim 2, wherein a plurality of bolt coupling holes is formed in the sliding guide parts and the sliding coupling parts, and the sliding guide parts and the sliding coupling parts are fixedly combined with each other by bolts and nuts using the bolt coupling holes.

4. The device for measuring the amount of moisture according to claim 3, wherein a packing member is placed in each of the sliding guide parts, so as to allow the chamber and the tray to be tightly combined with each other when the chamber and the tray are fixedly coupled with each other.

5. The device for measuring the amount of moisture according to claim 1, wherein the exhaust fans comprise a plurality of fans provided in parallel.

6. The device for measuring the amount of moisture according to claim 1, wherein the chamber comprises a controller configured to control a rotational speed of the exhaust fans.

7. The device for measuring the amount of moisture according to claim 1, wherein the mesh unit is a honeycomb-type mesh net.

8. The device for measuring the amount of moisture according to claim 1, wherein the external air flowing into the inner space of the chamber forms an air flow having straightness.
